(19) United States
(12) Patent Application Publication
(10) Pub. No.: US 2009/0187317 A1
(43) Pub. Date: Jul. 23, 2009

(54) CONTROL DEVICE OF AUTOMATIC TRANSMISSION

(75) Inventors: Kazumitsu Sugano, Aichi-ken (JP); Koji Oshima, Aichi-ken (JP); Eiji Fukushiro, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi, Aichi-ken (JP)

(21) Appl. No.: 12/373,226

(22) PCT Filed: Jul. 30, 2007
(86) PCT No.: PCT/JP2007/065316

§ 371 Date: Jan. 9, 2009

(30) Foreign Application Priority Data
Jul. 31, 2006 (JP) 2006-207880

(51) Int. Cl. G06F 19/00

(52) U.S. Cl. 701/54

(57) ABSTRACT

An ECU executes a program including a step of regulating an opening position of an electronic throttle to be A when determination on downshifting from a fifth gear to a second gear is outputted, a step of detecting the turbine revolution number NT, a step of regulating the opening position of the electronic throttle to be B (>A) when NT is not less than (the synchronous turbine revolution number NT (4) of a fourth gear+α), and a step of releasing regulation on the opening position of the electronic throttle when the shifting is completed.

### TECHNICAL FIELD

The present invention relates to shift control of a gear type automatic transmission, particularly to shift control over gears having two or more gears inbetween (for example, power-on downshifting from a fifth gear to a second gear in a six-gear transmission).

### BACKGROUND ART

An automatic transmission to be installed in a vehicle includes a gear type automatic transmission constructed by a fluid coupling such as a torque converter and a gear type transmission mechanism, and a continuously variable automatic transmission constructed by two pulleys for changing an effective diameter by oil pressure and a metal belt wound around the pulleys (it should be noted that the continuously variable transmission also includes an transmission other than the belt type).

The gear type automatic transmission is connected to an engine via the fluid coupling such as the torque converter. The gear type automatic transmission is constructed by a shift mechanism (the gear type transmission mechanism) having a plurality of powertrains, e.g., so as to automatically switch the powertrains based on an accelerator pedal position and a vehicle speed, that is, to automatically switch a gear ratio (a traveling speed gear). In the gear type automatic transmission, a clutch element, a brake element, and a one-way clutch element all serving as friction elements are engaged or disengaged into a predetermined state so as to determine a gear.

In such an automatic transmission (supposing that the automatic transmission is a six-gear transmission hereinafter), there is a case where shifting is performed over gears having two or more gears inbetween. At the time of such shifting, for example, in the case where the shifting is performed from a sixth gear implemented by engaging a first friction element and a second friction element to a third gear implemented by engaging two or more friction elements (such as a third friction element and a fourth friction element) other than the first friction element and the second friction element, that is, in the case where two or more friction elements are disengaged and two or more friction elements are engaged at the same time, or so-called double replacement shifting is performed, smooth shifting is achieved and shift time period is shortened.

Specifically, disengagement of the first friction element is started from a state in the sixth gear, disengagement of the second friction gear is started, engagement of the third friction element is completed, and then engagement of the fourth friction element is completed. Thereby, by causing the four friction elements to move slidingly at the same time, an intermediate shift gear between the sixth and third gears to be implemented by engaging the second friction element and the third friction element or the fourth friction element is not implemented, and the shifting is continuously performed to a final target shift gear so as not to perform the shifting twice. Therefore, smooth shifting is achieved and the shift time period is shortened.

In a shift control device of such an automatic transmission, generally in the case of performing a series of shift control, in order to prevent a change in the friction elements under the control and shift shock due to an abrupt change in the oil pressure, a change in a target shift gear is inhibited within a time range after a predetermined time period after the shift control is started to implementation of the final target shift gear and completion of the shift control. In other words, so-called re-shifting inhibition control is performed. Therefore, in the case where for example a driver changes the pressing amount of an accelerator during the double replacement shifting, causing a situation in which the shift gear in a shift map is different from the final target shift gear of the double replacement shifting being currently performed, there is a problem that it takes a long time to finally obtain the shift gear on a shift line as intended by the driver. Republished WO 2003/029699 discloses a shift control device of an automatic transmission capable of quickly responding to a demand and smoothly achieving double replacement control even in the case where a driver changes a shift intention after a change in a target shift gear is inhibited and demands shifting to another shift gear at the time of shifting achieved by performing replacement control a plurality of times as mentioned above. The shift control device of the automatic transmission disclosed in the above patent document is a shift control device of an automatic transmission provided with a shift controller for implementing a plurality of forward shift gears by engagement/disengagement control of a plurality of friction elements involved in the shifting of the automatic transmission. The shift control device of the automatic transmission includes: a double replacement shifting determiner determining shifting from an Nth gear implemented by at least engaging a first friction element and a second friction element to an (N−α)th gear implemented by at least disengaging the first friction element and the second friction element and engaging a third friction element and a fourth friction element, the (N−α)th gear having at least one or more intermediate shift gear implemented by engaging the second friction element and the third friction element relative to the Nth gear; a jumping shifting controller performing the shifting from the Nth gear to the (N−α)th gear by at least disengaging the first friction element, engaging the fourth friction element, lowering engagement force of the second friction element before a gear ratio reaches a gear ratio corresponding to the intermediate shift gear, and at least disengaging the second friction element and engaging the third friction element after the gear ratio exceeds the gear ratio corresponding to the intermediate shift gear when the double replacement shifting is determined; a target-shift-gear change inhibitor determining to inhibit a change in a target shift gear from the (N−α)th gear at predetermined timing after start of the shifting until completion of shift control when the shifting is performed from the Nth gear to the (N−α)th gear; and a target-shift-gear change permitter reconfirming the shift intention of the driver when the gear ratio reaches the gear ratio corresponding to the intermediate shift gear, and in the case where the target shift gear is different from the (N−α)th gear, permitting the change in the target shift gear to a shift gear in accordance with the intention of the driver even when the change in the target shift gear is inhibited.

According to this shift control device of the automatic transmission, the double replacement shifting determiner determines the shifting from the Nth gear implemented by at least engaging the first friction element and the second friction element to the (N−α)th gear implemented by at least disengaging the first friction element and the second friction element and engaging the third friction element and the fourth friction element, the (N−α)th gear having at least one or more intermediate shift gear relative to the Nth gear. When this double replacement shifting is determined, the jumping shifting controller performs the shifting from the Nth gear to the (N−α)th gear by at least disengaging the first friction element, engaging the fourth friction element, lowering the engagement force of the second friction element before the gear ratio reaches the gear ratio corresponding to the intermediate shift gear, and at least disengaging the second friction element and engaging the third friction element after the gear ratio exceeds the gear ratio corresponding to the intermediate shift gear. The target-shift-gear change permitter reconfirms the shift intention of the driver when a ratio between input revolution and output revolution, that is, the gear ratio reaches the gear ratio corresponding to the intermediate shift gear implemented by engaging the second friction element and the third friction element, and in the case where the target shift gear is different from the (N−α)th gear, permits the change in the target shift gear to the shift gear in accordance with the intention of the driver even after the change in the target shift gear is inhibited. Therefore, in the case where the shift intention of the driver is changed during the double replacement control even after the change in the target shift gear is inhibited, the shifting is not necessarily performed again after completion of the double replacement but the shift intention of the driver can be reflected in the middle of the double replacement shifting. Consequently, it is possible to quickly achieve the shifting in accordance with the demand of the driver.

For example, as in the above shift control, in the case where a (N−1)th gear is implemented at the time of downshifting from the Nth gear to a (N−2)th gear, there is a problem described below with regard to a friction engagement element to be disengaged in the Nth gear and engaged in the (N−1)th gear and the (N−2)th gear (a clutch and a brake of the automatic transmission such as a friction engagement element referred to as an input clutch). In downshifting control for switching such a friction engagement element from a disengaged state to an engaged state, an opening position of an electronic throttle is conventionally regulated for regulating torque of an engine in order to improve the feeling of the shift control and durability of the friction engagement element.

However, when the opening position of the electronic throttle is uniformly regulated so as to generate optimal engine torque at the time of synchronization of the (N−2)th gear (as not strictly regulated, the throttle may be largely opened in some cases), a rise in the turbine revolution number (the output shaft revolution number of a torque converter, that is, the input shaft revolution number of a gear type transmission mechanism, is large. Therefore, hydraulic control of the friction engagement element for implementing the (N−1)th gear serving as an intermediate gear is not favorably performed (timing for supplying engagement oil pressure is not easily determined so that the shift shock is easily generated).

Meanwhile, when the opening position of the electronic throttle is uniformly regulated so as to generate optimal engine torque at the time of synchronization of the (N−1)th gear (as strictly regulated, the throttle is not largely opened), the rise in the turbine revolution number is small. Therefore, shift time period until the (N−2)th gear serving as the final gear is implemented is extended.

However, the republished WO 2003/029699 mentioned above only discloses that shifting is performed over gears via at least one intermediate shift gear in shift control over the gears having two or more gears inbetween, thus being incapable of solving the above problems.

### DISCLOSURE OF THE INVENTION

The present invention was made in order to solve the above problems, and an object of the present invention is to provide a control device of an automatic transmission that avoids generation of shift shock while not extending a shift time period in shift control over gears having two or more gears inbetween.

A control device of an automatic transmission according to the present invention controls a gear type automatic transmission including a gear mechanism for implementing a desired shift gear by switching a plurality of friction engagement elements between an engaged state and a disengaged state. In this automatic transmission, in the case where shifting is performed over gears having two or more gears inbetween via an intermediate shift gear, a state in the shift gear before the shifting and a state in the intermediate shift gear and the shift gear after the shifting are different from each other with regard to at least of the plurality of one friction engagement elements. This control device includes a detector detecting the shifting performed over the gears having two or more gears inbetween via the intermediate shift gear, and a controller changing a control mode of an opening position of an electronic throttle of an engine coupled to the automatic transmission before and after implementation of the intermediate shift gear.

According to the present invention, the state in the shift gear before the shifting and the state in the intermediate shift gear are different from each other with regard to at least one friction engagement element in the intermediate shift gear implemented between the gears in the case of performing the shifting over the gears having two or more gears inbetween. For example, the friction engagement element is disengaged before the shifting and engaged in the intermediate shift gear. The control mode of the opening position of the electronic throttle within a time range from start of the shifting to implementation of this intermediate shift gear and the control mode of the opening position of the electronic throttle within a time range from the implementation of this intermediate shift gear to completion of the shifting are changed. Within the time range from the start of the shifting to the implementation of this intermediate shift gear, the opening position of the electronic throttle is not strictly limited so as to allow the electronic throttle to be largely opened, and the input revolution number to the automatic transmission (the turbine revolution number) is promptly increased to the synchronous revolution number of the intermediate shift gear (in the case of downshifting). Thereby, the shift time period is not extended. Within the time range from the implementation of this intermediate shift gear to the completion of the shifting, the opening position of the electronic throttle is strictly limited so as not to allow the electronic throttle to be largely opened, and the input revolution number to the automatic transmission (the turbine revolution number) is slowly increased to the synchronous revolution number of a final shift gear (in the case of downshifting). Thereby, a rise in the revolution number more than the synchronous revolution number of the final shift gear is prevented so as to avoid the generation of the shift shock. As a result, it is possible to provide the control device of the automatic transmission that avoids the generation of the shift shock while not extending the shift time period in the shift control over the gears having two or more gears inbetween.

It should be noted that the control mode may be set as below. With the time range from the start of the shifting to the implementation of this intermediate shift gear, the opening position of the electronic throttle is strictly limited so as not to allow the electronic throttle to be largely opened, and the input revolution number to the automatic transmission (the turbine revolution number) is slowly increased to the synchronous revolution number of the intermediate shift gear (in the case of downshifting). Thereby, the rise in the revolution number more than the synchronous revolution number of the intermediate shift gear is prevented so as to avoid the generation of the shift shock. Within the time range from the implementation of this intermediate shift gear to the completion of the shifting, the opening position of the electronic throttle is not strictly limited so as to allow the electronic throttle to be largely opened, and the input revolution number to the automatic transmission (the turbine revolution number) is promptly increased to the synchronous revolution number of the final shift gear (in the case of downshifting). Thereby, the shift time period is not extended.

Preferably, the control device of the automatic transmission according to the present invention further includes a detecting unit for detecting the input revolution number to be inputted to the gear mechanism. The shifting over the gears having two or more gears inbetween is downshifting. The controller determines that the intermediate shift gear is already implemented when the input revolution number is not less than the preliminarily fixed revolution number, and changes the control mode of the opening position of the electronic throttle.

According to the present invention, in the case where the shifting over the gears having two or more gears inbetween is the downshifting, it is possible to determine that the intermediate shift gear is already implemented based on an increase in the input revolution number (that is, the turbine revolution number) to be inputted to the gear mechanism.

More preferably, the controller determines that the intermediate shift gear is already implemented when the input revolution number is not less than the revolution number set in relation to the synchronous revolution number of the intermediate shift gear, and changes the control mode of the opening position of the electronic throttle.

According to the present invention, when the input revolution number (that is, the turbine revolution number) is not less than the revolution number set by adding the extra revolution number to the synchronous revolution number of the intermediate shift gear, it is possible to determine that the intermediate shift gear is already implemented. Particularly, since it is determined based on the revolution number set by adding the extra revolution number, it is possible to appropriately determine that the intermediate shift gear is already implemented in consideration to individual differences in the engine and the automatic transmission.

More preferably, the controller changes the control mode of the opening position of the electronic throttle before and after the implementation of the intermediate shift gear.

According to the present invention, since the control mode of the opening position of the electronic throttle (such as the limit amount) before and after the implementation of the intermediate shift gear, it is possible to avoid the shift shock and extension of the shift time period.

More preferably, the controller increases the limit amount of the opening position of the electronic throttle after the implementation of the intermediate shift gear more than before the implementation of the intermediate shift gear.

According to the present invention, within the time range from the start of the shifting to the implementation of this intermediate shift gear, the opening position of the electronic throttle is not strictly limited so as to allow the electronic throttle to be largely opened, and the input revolution number to the automatic transmission (the turbine revolution number) is promptly increased to the synchronous revolution number of the intermediate shift gear. Thereby, it is possible to avoid extension of the shift time period. Within the time range from the implementation of this intermediate shift gear to the completion of the shifting, the opening position of the electronic throttle is strictly limited so as not to allow the electronic throttle to be largely opened, and the input revolution number to the automatic transmission (the turbine revolution number) is slowly increased to the synchronous revolution number of the final shift gear. Thereby, the rise in the revolution number more than the synchronous revolution number of the final shift gear can be prevented so as to avoid the generation of the shift shock.

### BRIEF DESCRIPTION OF THE DRAWINGS

FIG. 1 is a schematic configuration diagram showing a powertrain to be controlled by an ECU serving as a control device according to an embodiment of the present invention.

FIG. 2 is a skeleton diagram showing a gear train of an automatic transmission.

FIG. 3 is a working table of the automatic transmission.

FIG. 4 is a functional block diagram of the control device according to the embodiment of the present invention.

FIG. 5 is a flowchart showing a control structure of a program to be executed by the ECU serving as the control device according to the embodiment of the present invention.

FIG. 6 is a timing chart showing a state of the automatic transmission in the case where control is performed by the ECU serving as the control device according to the embodiment of the present invention.

### BEST MODES FOR CARRYING OUT THE INVENTION

An embodiment of the present invention will be described hereinafter with reference to the drawings. In the following description, the same parts are given the same reference numerals. Names and functions thereof are all the same. Therefore, a detailed description thereof will not be repeated.

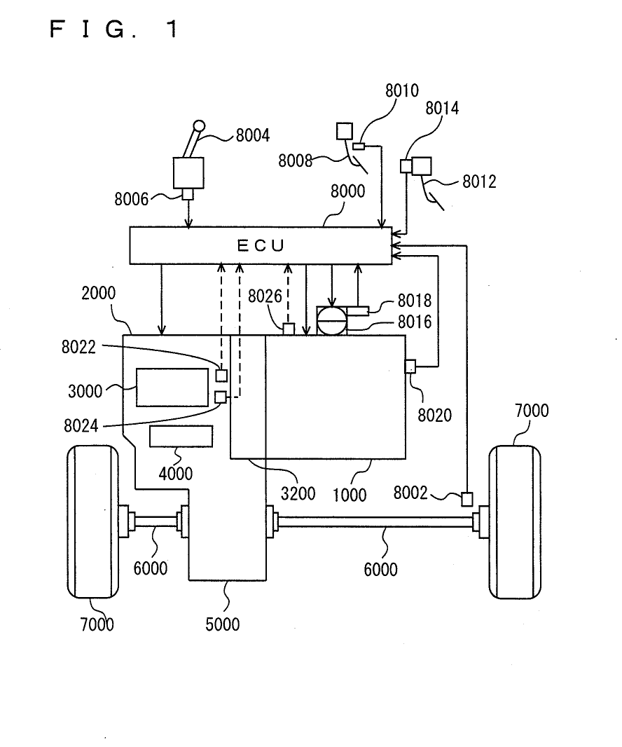

With reference to FIG. 1, a vehicle installed with a control device according to the embodiment of the present invention will be described. This vehicle is an FF (Front engine Front drive) vehicle. It should be noted that this vehicle may be a vehicle other than the FF vehicle or a vehicle installed with a non-six-gear automatic transmission.

The vehicle includes an engine 1000, a six-gear automatic transmission 2000, a planetary gear unit 3000 constituting a portion of automatic transmission 2000, an oil hydraulic circuit 4000 constituting a portion of automatic transmission 2000, a differential gear 5000, a drive shaft 6000, front wheels 7000, and an ECU (Electronic Control Unit) 8000.

Engine 1000 is an internal combustion engine for combusting an air-fuel mixture of fuel injected from an injector (not shown) and the air in a combustion chamber of a cylinder. A piston in the cylinder is pushed down by the combustion and a crankshaft is rotated.

Automatic transmission 2000 is coupled to engine 1000 via a torque converter 3200. Automatic transmission 2000 implements a desired gear so as to shift the revolution number of the crankshaft to the desired revolution number.

An output gear of automatic transmission 2000 is meshed with differential gear 5000. Drive shaft 6000 is coupled to differential gear 5000 by spline-fitting or the like. Mechanical power is transmitted to right and left front wheels 7000 via drive shaft 6000.

A vehicle speed sensor 8002, a position switch 8006 of a shift lever 8004, an accelerator press-down degree sensor 8010 of an accelerator pedal 8008, a stroke sensor 8014 of a brake pedal 8012, a throttle opening position sensor 8018 of an electronic throttle valve 8016, an engine speed sensor 8020, an input shaft speed sensor 8022, an output shaft speed sensor 8024, and a water temperature sensor 8026 are connected to ECU 8000 via a harness and the like.

Vehicle speed sensor 8002 detects a vehicle speed from the revolution number of drive shaft 6000, and transmits a signal representing a detection result to ECU 8000. A position of shift lever 8004 is detected by position switch 8006, and a signal representing a detection result is transmitted to ECU 8000. A gear of automatic transmission 2000 is automatically implemented in response to the position of shift lever 8004.

Accelerator press-down degree sensor 8010 detects a position of accelerator pedal 8008 and transmits a signal representing a detection result to ECU 8000. Stroke sensor 8014 detects the stroke amount of brake pedal 8012 and transmits a signal representing a detection result to ECU 8000.

Throttle opening position sensor 8018 detects an opening position of electronic throttle valve 8016 adjusted by an actuator and transmits a signal representing a detection result to ECU 8000. The air amount to be taken into engine 1000 (an output of engine 1000) is adjusted by electronic throttle valve 8016.

Engine speed sensor 8020 detects the revolution number of an output shaft (the crankshaft) of engine 1000 and transmits a signal representing a detection result to ECU 8000. Input shaft speed sensor 8022 detects the input shaft revolution number NI of automatic transmission 2000 (the turbine revolution number NT of torque converter 3200) and transmits a signal representing a detection result to ECU 8000. Output shaft speed sensor 8024 detects the output shaft revolution number NO of automatic transmission 2000 and transmits a signal representing a detection result to ECU 8000.

Water temperature sensor 8026 detects a temperature of coolant of engine 1000 (a water temperature) and transmits a signal representing a detection result to ECU 8000.

ECU 8000 controls devices so that the vehicle is in a desired state (a state in which automatic transmission 2000 is actuated) based on the signals transmitted from vehicle speed sensor 8002, position switch 8006, accelerator press-down degree sensor 8010, stroke sensor 8014, throttle opening position sensor 8018, engine speed sensor 8020, input shaft speed sensor 8022, output shaft speed sensor 8024, water temperature sensor 8026, and the like, a map, and a program stored in a ROM (Read Only Memory).

In the present embodiment, ECU 8000 controls automatic transmission 2000 so that any of first to sixth gears is implemented in the case where a D (drive) position is selected as a shift position of automatic transmission 2000 by placing shift lever 8004 at the D (drive) position. Since any of the first to sixth gears is implemented, automatic transmission 2000 can transmit drive force to front wheels 7000. It should be noted that a gear of higher speed than the sixth gear, that is, a seventh gear or an eighth gear, may be implemented in the D position.

A gear to be implemented is determined based on a shift map preliminarily made with the vehicle speed and the accelerator pedal position used as parameters. It should be noted that the transmission may determine a gear to be implemented based on such a shift map and additionally perform up-shifting or downshifting in accordance with an operation of shift lever 8004 by a driver so as to implement the gear to be implemented.

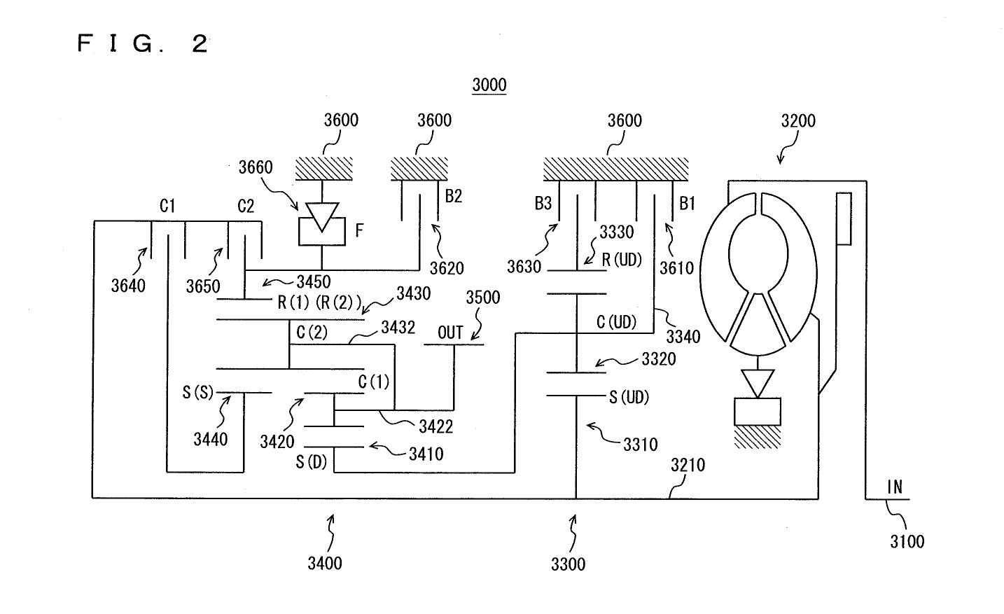

With reference to FIG. 2, planetary gear unit 3000 will be described. Planetary gear unit 3000 is connected to torque converter 3200 having an input shaft 3100 coupled to the crankshaft. Planetary gear unit 3000 includes a first set of planetary gear mechanism 3300, a second set of planetary gear mechanism 3400, an output gear 3500, B1, B2 and B3 brakes 3610, 3620, and 3630 fixed to a gear case 3600, C1 and C2 clutches 3640 and 3650, and a one-way clutch F 3660.

First set 3300 is a single pinion type planetary gear mechanism. First set 3300 includes a sun gear S (UD) 3310, a pinion gear 3320, a ring gear R (UD) 3330, and a carrier C (UD) 3340.

Sun gear S (UD) 3310 is coupled to an output shaft 3210 of torque converter 3200. Pinion gear 3320 is rotatably supported on carrier C (UD) 3340. Pinion gear 3320 is meshed with sun gear S (UD) 3310 and ring gear R (UD) 3330.

Ring gear R (UD) 3330 is fixed to gear case 3600 by B3 brake 3630. Carrier C (UD) 3340 is fixed to gear case 3600 by B1 brake 3610.

Second set 3400 is a Ravigneaux type planetary gear mechanism. Second set 3400 includes a sun gear S (D) 3410, a short pinion gear 3420, a carrier C (1) 3422, a long pinion gear 3430, a carrier C (2) 3432, a sun gear S (S) 3440, and a ring gear R (1) (R (2)) 3450.

Sun gear S (D) 3410 is coupled to carrier C (UD) 3340. Short pinion gear 3420 is rotatably supported on carrier C (1) 3422. Short pinion gear 3420 is meshed with sun gear S (D) 3410 and long pinion gear 3430. Carrier C (1) 3422 is coupled to output gear 3500.

Long pinion gear 3430 is rotatably supported on carrier C (2) 3432. Long pinion gear 3430 is meshed with short pinion gear 3420, sun gear S (S) 3440, and ring gear R (1) (R (2)) 3450. Carrier C (2) 3432 is coupled to output gear 3500.

Sun gear S (S) 3440 is coupled to output shaft 3210 of torque converter 3200 by C1 clutch 3640. Ring gear R (1) (R (2)) 3450 is fixed to gear case 3600 by B2 brake 3620 and coupled to output shaft 3210 of torque converter 3200 by C2 clutch 3650. Ring gear R (1) (R (2)) 3450 is coupled to one-way clutch F 3660 and disabled in rotation during drive in the first gear.

One-way clutch F 3660 is provided in parallel with B2 brake 3620. That is, an outer race of one-way clutch F 3660 is fixed to gear case 3600, and an inner race is coupled to ring gear R (1) (R (2)) 3450 via a rotation shaft.

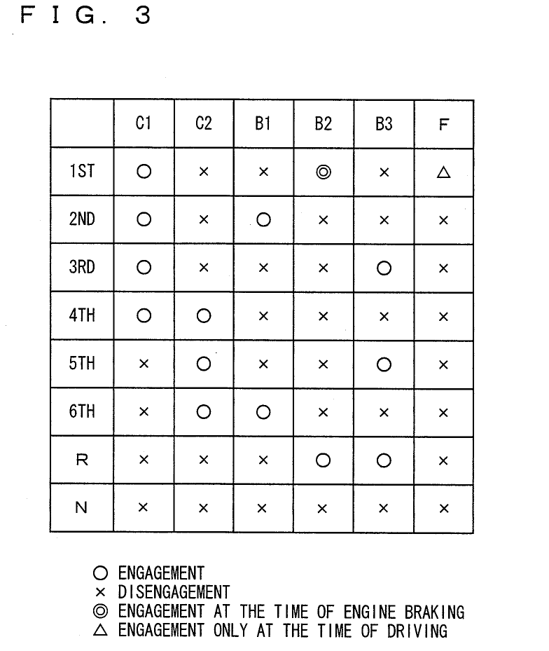

FIG. 3 shows a working table illustrating a relationship between the shift gears and working states of the clutches and the brakes. The circle indicates engagement. The cross indicates disengagement. The double circle indicates engagement only at the time of engine braking. The triangle indicates engagement only at the time of driving. First to sixth forward gears and a reverse gear are implemented by operating the brakes and the clutches in combinations shown in this working table. For example, in power-on downshifting from a fifth gear to a second gear, disengaged C1 clutch 3640 is engaged and engaged C2 clutch 3650 is disengaged. It should be noted that such shifting (from the fifth gear to the second gear) is also referred to as clutch-to-clutch shifting (input switching) where an engaged friction engagement element (such as the clutch and the brake, particularly C2 clutch 3650 here) is disengaged and other disengaged friction engagement element (such as the clutch and the brake, particularly C1 clutch 3640 here) is engaged.

In such power-on downshifting from the fifth gear to the second gear, a fourth gear serving as an intermediate shift gear is implemented between the gears. Such shifting is performed over the gears having two or more gears inbetween via the intermediate shift gear. A state (a disengaged state) in the shift gear before the shifting (the fifth gear) and a state (an engaged state) in the intermediate shift gear (the fourth gear) and the shift gear after the shifting (the second gear) are different from each other with regard to at least one friction engagement element (C1 clutch 3640 here).

ECU 8000 serving as the control device according to the present embodiment changes a regulated value in electronic-throttle-opening-position regulating control before and after implementation of the intermediate shift gear (comparing the turbine revolution number and the synchronous revolution number of the intermediate shift gear for determination). Specifically, the regulation amount of the opening position of the electronic throttle is set to be A until the implementation of the fourth gear serving as the intermediate shift gear. The regulation amount of the opening position of the electronic throttle is set to be B that is more than A within a time range after implementation of the fourth gear serving as the intermediate shift gear (after the turbine revolution number reaches an amount set by adding a threshold value a to the synchronous revolution number of the fourth gear or more) to implementation of a final shift gear.

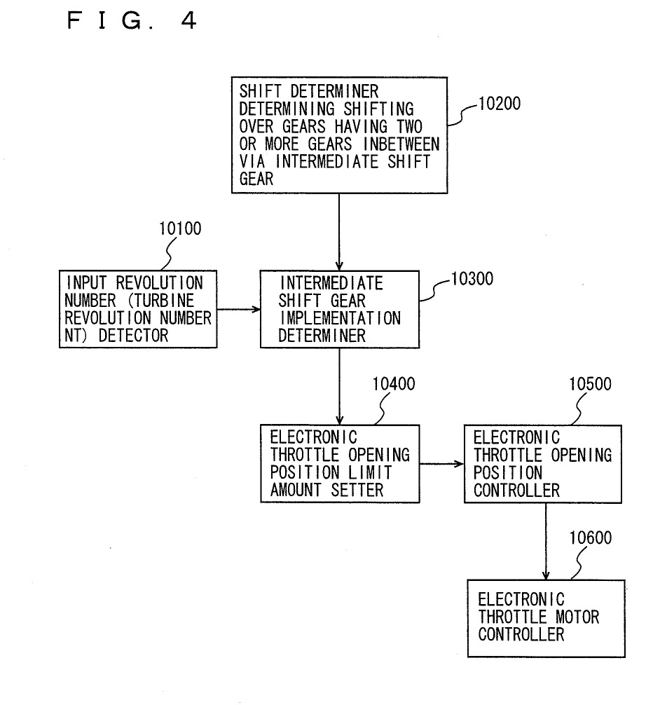

A functional block diagram of the control device of the automatic transmission according to the present embodiment will be described with reference to FIG. 4.

As shown in FIG. 4, this control device includes an input revolution number (turbine revolution number NT) detector 10100, a shift determiner 10200 for determining the shifting over the gears having two or more gears inbetween via the intermediate shift gear, an intermediate shift gear implementation determiner 10300 connected to input revolution number (turbine revolution number NT) detector 10100 and shift determiner 10200 for determining the shifting over the gears having two or more gears inbetween via the intermediate shift gear, an electronic throttle opening position limit amount setter 10400 connected to intermediate shift gear implementation determiner 10300, an electronic throttle opening position controller 10500 connected to electronic throttle opening position limit amount setter 10400, and an electronic throttle motor controller 10600 connected to electronic throttle opening position controller 10500.

Intermediate shift gear implementation determiner 10300 determines whether or not the intermediate shift gear is already implemented based on the input revolution number (turbine revolution number NT) in the case where it is determined that the shifting is performed over the gears having two or more gears inbetween via the intermediate shift gear. For example, it is determined that the intermediate shift gear is already implemented, when the turbine revolution number NT reaches the revolution number set by adding threshold value α (>0) to the synchronous revolution number of the intermediate shift gear or more. In such a way, it is possible to accurately determine that the intermediate shift gear is already implemented in consideration of individual differences in the engine and the automatic transmission.

Electronic throttle opening position limit amount setter 10400 sets the limit amount of the opening position of the electronic throttle by switching the limit amount within a time range from start of the shifting over the gears having two or more gears inbetween via the intermediate shift gear to the implementation of the intermediate shift gear (this limit amount is set to be A here) and the limit amount within a time range from the implementation of the intermediate shift gear to a point before the implementation of the final shift gear (this limit amount is set to be B (>A) here). It should be noted that the present invention is not limited to such switching of the limit amount. That is, the limit amount is not necessarily switched, but anything as long as limit of the opening position of the electronic throttle is changed before and after the implementation of the intermediate shift gear can be adapted. A volume relationship between the limit amount A and the limit amount B is also only an example. The present invention can be achieved in the reverse case.

Electronic throttle opening position controller 10500 controls the opening position of electronic throttle valve 8016 so as not to exceed the limit amount set in electronic throttle opening position limit amount setter 10400. That is, within the time range from the start of the shifting to the implementation of the fourth gear serving as this intermediate shift gear, the opening position of electronic throttle valve 8016 is not strictly limited (the limit amount is small) so as to allow electronic throttle valve 8016 to be largely opened, and the turbine revolution number NT is promptly increased to the synchronous revolution number (NT (4)) of the fourth gear serving as the intermediate shift gear. Thereby, shift time period is not extended. Within the time range from the implementation of the fourth gear serving as this intermediate shift gear to completion of the shifting (implementation of the second gear), the opening position of electronic throttle valve 8016 is strictly limited (the limit amount is large) so as not to allow electronic throttle valve 8016 to be largely opened, and the turbine revolution number NT is slowly increased to the synchronous revolution number of the second gear serving as the final shift gear. Thereby, a rise in the revolution number more than the synchronous revolution number of the second gear is prevented so as to avoid generation of shift shock.

The control device of the automatic transmission according to the present embodiment having such a functional block can be realized by either hardware mainly configured by a digital circuit or an analog circuit or software mainly configured by a CPU (Central Processing Unit) included in ECU 8000, a memory, and a program read from the memory and executed by the CPU. In general, it is said that the control device realized by the hardware is advantageous in terms of working speed, and the control device realized by the software is advantageous in terms of change in design. Hereinafter, the control device realized by the software will be described.

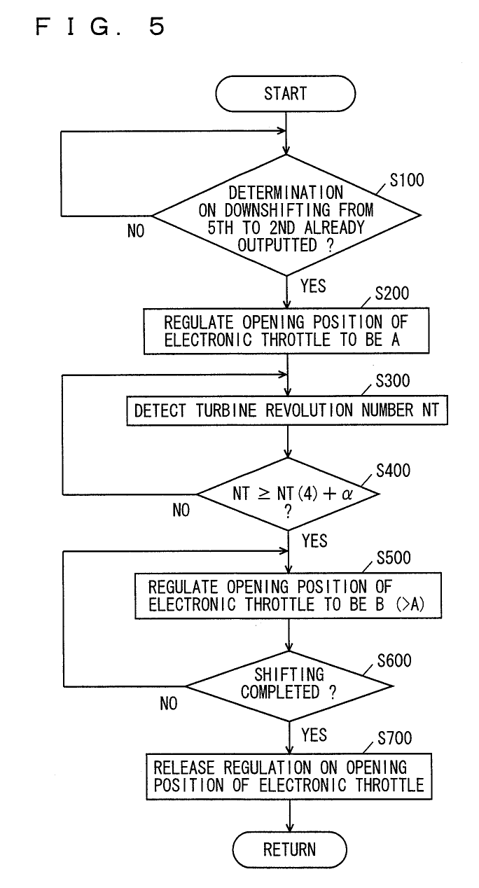

With reference to FIG. 5, a control structure of the program to be executed by the ECU of FIG. 4 will be described. It should be noted that this program is repeatedly executed in a preliminarily fixed time cycle.

ECU 8000 determines whether or not determination on downshifting from the fifth gear to the second gear is already outputted in Step (hereinafter, Step is described as S) 100. At this time, ECU 8000 make the determination based on the accelerator pedal position, the vehicle speed, a downshifting shift line, and the like. When it is determined that the determination on the downshifting from the fifth gear to the second gear is already outputted (YES in S100), the processing is moved to S200. If not (NO in S100), the processing is returned to S100 to be held until it is determined that the determination on the downshifting from the fifth gear to the second gear is already outputted.

ECU 8000 regulates (limits) the opening position of the electric throttle to be A (>0) in S200.

ECU 8000 detects the turbine revolution number NT in S300. At this time, ECU 8000 detects the turbine revolution number NT based on an input signal from input shaft speed sensor 8022.

ECU 8000 determines whether or not the turbine revolution number NT is not less than (the synchronous revolution number NT (4) of the fourth gear serving as the intermediate shift gear+α) (α>0) in S400. That is, ECU 8000 determines whether or not the turbine revolution number NT reaches the revolution number set by adding threshold value α (>0) to the synchronous revolution number NT (4) of the fourth gear serving as the intermediate shift gear or more. When the turbine revolution number NT is not less than (the synchronous revolution number NT (4) of the fourth gear serving as the intermediate shift gear+α) (YES in S400), the processing is moved to S500. If not (NO in S400), the processing is returned to S300.

ECU 8000 regulates (limits) the opening position of the electronic throttle to be B (>A>0) in S500.

ECU 8000 determines whether or not the shifting is completed based on the turbine revolution number NT and the like in S600. When the shifting (from the fifth gear to the second gear) is completed (YES in S600), the processing is moved to S700. If not (NO in S600), the processing is returned to S500.

ECU 8000 releases the regulation (the limit) on the opening position of the electronic throttle in S700.

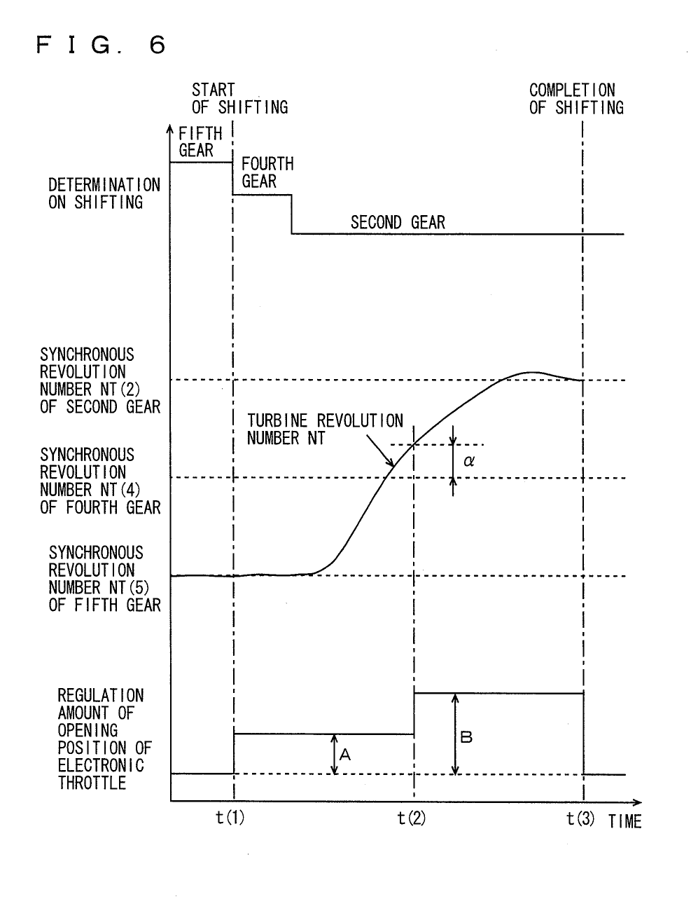

An action of the control device of the automatic transmission according to the present embodiment based on the structure and the flowchart described above will be described with reference to a timing chart of FIG. 6.

When the determination on the power-on downshifting from the fifth gear to the second gear via the fourth gear serving as the intermediate shift gear is outputted to automatic transmission 2000 (YES in S100), the opening position of the electronic throttle is regulated to be A (S200). This timing is time t (1) in FIG. 6.

While regulating the opening position of the electronic throttle to be A, the gradually increasing turbine revolution number NT is detected (S300). When the turbine revolution number NT is (the synchronous revolution number NT (4) of the fourth gear serving as the intermediate shift gear+α) (YES in S400), the opening position of the electronic throttle is regulated to be B (>A) (S500). This timing is time t (2) in FIG. 6.

Then, while more strongly regulating the opening position of the electronic throttle to be B, when it is determined that the shifting is completed based on the gradually increasing turbine revolution number NT and the like (YES in S600), the regulation on the opening position of the electronic throttle is released (S700). This timing is time t (3) in FIG. 6.

As described above, with the control device of the automatic transmission according to the present embodiment, the limit amount of the opening position of the electronic throttle is switched between limit amount A within the time range from the start of the shifting over the gear having two or more gears inbetween via the intermediate shift gear to a point before the implementation of the intermediate shift gear, and limit amount B (>A) within the time range from the implementation of the intermediate shift gear to a point before the implementation of the final shift gear. Within the time range from the start of the shifting to the implementation of the fourth gear serving as the intermediate shift gear, the opening position of the electronic throttle is not strictly limited (small limit amount A) so as to allow the electronic throttle to be largely opened, and the turbine revolution number NT is promptly increased to the synchronous revolution number (NT (4)) of the fourth gear serving as the intermediate shift gear. Thereby, the shift time period is not extended. Within the time range from the implementation of the fourth gear serving as this intermediate shift gear to the completion of the shifting (the implementation of the second gear), the opening position of the electronic throttle is strictly limited (limit amount B being more than A) so as not to allow the electronic throttle to be largely opened, and the turbine revolution number NT is slowly increased to the synchronous revolution number of the second gear serving as the final shift gear. Thereby, the rise in the revolution number more than the synchronous revolution number of the second gear is prevented so as to avoid the generation of the shift shock. Therefore, it is possible to avoid the generation of the shift shock while not extending the shift time period in the shift control over the gears having two or more gears inbetween.

It should be noted that as confirmation, the description in the above embodiment does not exclude a case of a reversed volume relationship between A and B from the scope of the present invention.

The embodiment disclosed here should not be considered as restrictive, but is an example in all respects. The scope of the present invention is not defined by the above description but claims. The present invention shall include all variations within equivalent meanings and scope to the claims.

1. A control device of a gear type automatic transmission provided with a gear mechanism for implementing a desired shift gear by switching a plurality of friction engagement elements between an engaged state and a disengaged state, in a case where shifting is performed over gears having two or more gears inbetween via an intermediate shift gear, a state in the shift gear before the shifting and a state in the intermediate shift gear and the shift gear after the shifting being different from each other with regard to at least one of said plurality of friction engagement elements, the control device of the automatic transmission comprising:
a detector detecting the shifting performed over the gears having two or more gears inbetween via the intermediate shift gear; and
a controller changing a control mode of an opening position of an electronic throttle of an engine coupled to said automatic transmission before and after implementation of said intermediate shift gear.

2. The control device of the automatic transmission according to claim 1, wherein
said control device further includes a detecting unit detecting the input revolution number to be inputted to said gear mechanism,
said shifting over the gears having two or more gears inbetween is downshifting, and
said controller determines that said intermediate shift gear is already implemented when said input revolution number is not less than the preliminarily fixed revolution number, and changes the control mode of said opening position of the electronic throttle.

3. The control device of the automatic transmission according to claim 2, wherein
said controller determines that said intermediate shift gear is already implemented when said input revolution number is not less than the revolution number set in relation to the synchronous revolution number of said intermediate shift gear, and changes the control mode of said opening position of the electronic throttle.

4. The control device of the automatic transmission according to any of claims 1 to 3, wherein
said controller changes the control mode of said opening position of the electronic throttle before and after the implementation of said intermediate shift gear.

5. The control device of the automatic transmission according to claim 4, wherein
said controller increases a limit amount of said opening position of the electronic throttle after the implementation of said intermediate shift gear more than before the implementation of said intermediate shift gear.
